(19) United States
(12) Patent Application Publication
(10) Pub. No.: US 2019/0159462 A1
(43) Pub. Date: May 30, 2019

(54) SERRATIA MARCESCENS BIOCONTROL STRAIN EFFICIENTLY INHIBITING AFLATOXINS PRODUCTION BY ASPERGILLUS FLAVUS AND APPLICATION THEREOF

(71) Applicant: OIL CROPS RESEARCH INSTITUTE, CHINESE ACADEMY OF AGRICULTURAL SCIENCES, Wuhan (CN)

(72) Inventors: Peiwu LI, Wuhan (CN); Xiaoxia DING, Wuhan (CN); Yizhen BAI, Wuhan (CN); Qi ZHANG, Wuhan (CN)

(21) Appl. No.: 16/204,691

(22) Filed: Nov. 29, 2018

(30) Foreign Application Priority Data
Nov. 29, 2017 (CN) 201711229014.0

(51) Int. Cl. A01N 63/00; C12R 1/43; A23B 7/155; A23B 7/16

(52) U.S. Cl. CPC A01N 63/00; C12R 1/43; A23V 2002/00; A23B 7/16; A23B 7/155

(57) ABSTRACT

The present invention relates to the microbiological field, and particularly relates to a Serratia marcescens biocontrol strain efficiently inhibiting production of aflatoxins by Aspergillus flavus and an application thereof. The Serratia marcescens biocontrol strain 3J4SM was deposited at China Center for Type Culture Collection (CCTCC) on Jun. 13, 2017, and the accession number of the strain is CCTCC No. M2017328. The Serratia marcescens biocontrol strain 3J4SM can be used to inhibit production of aflatoxins by Aspergillus flavus and prevent grain crops from aflatoxin pollution.

### CROSS-REFERENCE TO RELATED APPLICATION

This application claims the benefit of China application serial No. 2017112290140, filed on Nov. 29, 2017. The entirety of the above-mentioned patent application is hereby incorporated by reference herein and made a part of this specification.

### FIELD

The present invention relates to the microbiological field, and particularly relates to a Serratia marcescens biocontrol strain efficiently inhibiting production of aflatoxins by Aspergillus flavus and an application thereof.

### BACKGROUND OF THE INVENTION

Aspergillus flavus is a pathogenic fungus capable of producing powerful carcinogenic and highly toxic mycotoxins aflatoxins. Aflatoxins include families B, G and M, in which B1 is the most common and most toxic. The aflatoxins can pollute grain crops such as peanuts and maize extensively, seriously threatening the health of human and livestock, and causing a huge economic loss. Therefore, it is urgent to strengthen prevention and control of Aspergillus flavus and toxin pollution.

Currently, there are three methods of prevention and control of Aspergillus flavus, namely, physical, chemical and biological control methods. However, chemical control has high cost and is likely to cause environmental pollution. In addition, while chemical control is adopted for controlling pathogenic bacteria, the pathogenic bacteria are prone to drug tolerance and even drug resistance to chemical agents. Physical control is time-consuming and laborious, its detoxification rate is not high, and it easily causes nutrient loss. Biological control has advantages of being safe, efficient and durable. Therefore, it is of great significant to strengthen the research on the biological prevention and control of Aspergillus flavus for China's agricultural industry and economic benefits. Reports that serratia marcescens is used for inhibiting Aspergillus flavus are not seen in existing research.

### SUMMARY OF THE INVENTION

The present invention provides a Serratia marcescens biocontrol strain 3J4SM efficiently inhibiting production of aflatoxins by Aspergillus flavus and an application thereof. The Serratia marcescens biocontrol strain 3J4SM can significantly inhibit production of aflatoxins by Aspergillus flavus, and also has an extremely good effect on inhibiting aflatoxins production by Aspergillus flavus for peanuts from different sources.

In one embodiment, the Serratia marcescens biocontrol strain 3J4SM was deposited at China Center for Type Culture Collection (CCTCC) on Jun. 13, 2017, the accession number of the strain is CCTCC No. M2017328, and the deposition address is Wuhan University, Wuhan, China.

According to the present invention, the Serratia marcescens biocontrol strain 3J4SM is isolated from peanut pods. A screening method comprises the following steps: performing gradient dilution on soil collected from a peanut field in Huangpi of Hubei Province, taking 100 μL of the diluted soil to an LB solid medium, performing plate coating for culture, picking growing bacteria with an inoculating loop, transferring the picked bacteria to a fresh LB solid medium for plate streaking, picking a single colony after transferring for several times, and performing co-culture tests on the picked single colony and Aspergillus flavus in a medium (namely performing co-culture antibacterial tests by in vitro inoculation of peanuts with the Aspergillus flavus) to measure toxin productivity; and finally screening a Serratia marcescens biocontrol strain 3J4SM capable of remarkably inhibiting Aspergillus flavus from generating toxins. The strain was deposited at China Center for Type Culture Collection (CCTCC) with an accession number CCTCC No. M2017328. The strain is identified with a 16S rDNA specific amplification technique and morphological characteristics and physiological and biochemical tests. The results show that the strain is Serratia marcescens belonging to enterobacteriaceae and Serratia.

TABLE 1
Major biological characteristics of Serratia marcescens 3J4SM:

| Gram | | | Culture | Culture | | | | | | Nitrate |
|---|---|---|---|---|---|---|---|---|---|---|
| staining | Spore | Capsule | temperature | time | urealysis | M.R test | Oxidase | glucose | citrates | reduction |
| Negative | No | No | 25-37° C. | 12-24 h | Negative | Negative | Negative | Positive | Positive | Positive |

In an embodiment, an inhibitor for inhibiting production of aflatoxins by Aspergillus flavus is provided which comprises biologically pure culture of the Serratia marcescens 3J4SM.

In an embodiment, the inhibitor is in a form of a liquid, a dust, a dry wettable powder or a dry wettable granule.

In an embodiment, the inhibitor is in a form of a liquid and the Serratia marcescens 3J4SM is present at a concentration of (1-9)×107 CFU/mL.

In an embodiment, the inhibitor is a fermentation liquid of the Serratia marcescens 3J4SM. A preparation method of the Serratia marcescens fermentation liquid comprises the following steps: activating the Serratia marcescens 3J4SM in an LB plate, performing culturing in an incubator at 37° C. for 24 h, picking a single colony of Serratia marcescens with a teasing needle, transferring the single colony to a liquid medium for shaking culture for 12-24h, sucking 1-3% of a culture solution, and transferring the culture solution to a fresh liquid medium for shaking culture for 12-24 h, so as to obtain the antagonistic Serratia marcescens 3J4SM fermentation liquid.

In an embodiment, an application of the inhibitor for inhibiting the production of aflatoxins by Aspergillus flavus is provided. The application is as follows: coating a surface of a biological sample with the inhibitor or mixing the inhibitor with a biological sample to inhibit the production of aflatoxins by Aspergillus flavus, so as to prevent the biological samples from aflatoxin pollution.

In an embodiment, an application of the Serratia marcescens 3J4SM for inhibiting the production of aflatoxins by Aspergillus flavus is provided. The specific application method is as follows: coating a surface of a biological sample with the fermentation liquid of Serratia marcescens 3J4SM or mixing the fermentation liquid of Serratia marcescens 3J4SM with a biological sample to inhibit production of aflatoxins by Aspergillus flavus, so as to prevent the biological samples from aflatoxin pollution.

The present invention has the following beneficial effects: the Serratia marcescens strain 3J4SM having an excellent effect on controlling Aspergillus flavus is separated from soil in the peanut field for the first time. The strain can be used to inhibit the Aspergillus flavus from generating the aflatoxins, so as to prevent aflatoxin pollution on grain crops.

### DETAILED DESCRIPTION

The method comprises the following steps: performing gradient dilution on soil collected from a peanut field in Huangpi of Hubei Province, taking 100 μL of the diluted soil to an LB solid medium, performing plate coating for culture, picking growing bacteria with an inoculating loop, transferring the picked bacteria to a fresh LB solid medium for plate streaking, picking a single colony after transferring for several times, performing co-culture tests on the picked single colony and Aspergillus flavus in a medium to measure toxin productivity, namely performing co-culture antibacterial tests by in vitro inoculation of peanuts with the Aspergillus flavus; and finally screening a strain 3J4SM capable of remarkably inhibiting the production of aflatoxins by Aspergillus flavus. The strain was deposited at China Center for Type Culture Collection (CCTCC) with an accession number of CCTCC No. M2017328.

### Embodiment 1

1) activating the Serratia marcescens 3J4SM in an LB plate, performing culturing in an incubator at 37° C. for 24 h, picking a single colony of Serratia marcescens with a teasing needle, transferring the single colony to a conical flask with 15 mL of LB liquid medium, and performing shaking culture at 28° C. and at 200r·min⁻¹ for 12h; sucking and transferring 1% of culture solution to a conical flask with 15 mL of LB liquid medium, and performing shaking culture at 28° C. and 200r·min⁻¹ for 12h to obtain the antagonistic strain fermentation liquid;
2) culturing the Serratia marcescens fermentation liquid (final concentration is 1×10⁷ CFU/mL) and thriving Aspergillus flavus suspension after 7 days of culture (final spore concentration is 5.0×10⁵ spores mL⁻¹) together in a Sabourand liquid medium at 28° C. and at 200 rpm for 5 days, wherein each treatment is repeated for 3 times; and
3) measuring the content of aflatoxin B1 in the culture solution (Table 2).

TABLE 2
Control effect of biocontrol bacteria on Aspergillus flavus

| | | A. flavus + CCTCC |
|---|---|---|
| Treatment | A. flavus | No. M 2017328 |
| Content of AFB1 (ng/ml) | 217.90 ± 2.19 | 13.78 ± 1.11 |

As can be seen from the test result, the Serratia marcescens strain CCTCC No. M2017328 has an aflatoxin inhibiting rate of 93.7%, showing that the strain has the capacity of inhibiting aflatoxin production.

### Embodiment 2

1) grinding “Zhonghua No. 6” peanut kernels taken from a peanut field of Hubei Province into powder, weighing and placing 1 g of the peanut powder to a culture dish, and at the same time adding 1 mL of Aspergillus flavus spore suspension (5×10⁵/mL) and 1 mL of CCTCC M2017328 bacterial liquid (1×10⁷ CFU/mL), wherein a Sabourand medium is used for replacing the CCTCC M2017328 fermentation liquid as a control;
2) culturing the inoculated peanut powder in an incubator at 28° C. for 9 days, then adding 15 mL of 70% aqueous methanol, and placing the mixture into a shaker for 30 min after being mixed in a vortex manner; taking 3 mL of supernatant, adding 8 mL of ultrapure water and performing vortex centrifugation;
3) taking 8 mL of supernatant, and measuring the content of aflatoxin B1 (Table 3) by an immunoaffinity column-HPLC method. The experiment is repeated for 3 times.

TABLE 3
Control effect of biocontrol bacteria on Aspergillus flavus

| | | A. flavus + CCTCC |
|---|---|---|
| Treatment | A. flavus | No. M 2017328 |
| Content of AFB1 (ng/ml) | 687.49 ± 44.61 | 98.95 ± 8.78 |

As can be seen from the test result, the strain CCTCC M2017328 on the “Zhonghua No. 6” peanuts has an aflatoxin inhibiting rate of approximately 85.6%, showing that the strain has a good effect of controlling aflatoxins during the storage of peanuts.

### Embodiment 3

1) taking 10 “Luhua No. 8” peanut kernels from a peanut field of Anhui Province, coating the surfaces of the peanut kernels with the Serratia marcescens 3J4SM fermentation liquid, and at the same time adding 1 mL of Aspergillus flavus spore suspension (5×10⁵/mL). A Sabourand medium is used for replacing the CCTCC M2017328 fermentation liquid as a control;
2) culturing the inoculated peanut kernels in an incubator at 28° C. for 9 days, then grinding the peanut kernels into peanut powder, adding 15 mL of 70% aqueous methanol, and placing the mixture into a shaker for 30 min after being mixed in a vortex manner; and taking 3 mL of supernatant, adding 8 mL of ultrapure water and performing vortex centrifugation;
3) taking 8 mL of supernatant, and measuring the content of aflatoxin B1 (Table 4) by an immunoaffinity column-HPLC method. The experiment is repeated for three times.

TABLE 4
Control effect of biocontrol bacteria on peanut Aspergillus flavus

| | | A. flavus + CCTCC |
|---|---|---|
| Treatment | A. flavus | No. M 2017328 |
| Content of AFB1 (ng/ml) | 466.53 ± 59.47 | 77.17 ± 9.42 |

As can be seen from the test result, the strain CCTCC M2017328 on the “Luhua No. 8” peanuts has an aflatoxin inhibiting rate of approximately 83.5%, showing that the strain has an extremely good biocontrol effect on peanuts of different kind sources.

What is claimed is:

1. An inhibitor for production of aflatoxins by Aspergillus flavus, comprise biologically pure culture of the Serratia marcescens 3J4SM deposited at China Center for Type Culture Collection (CCTCC) on Jun. 13, 2017 with an accession number CCTCC No. M2017328.

2. The inhibitor of claim 1, wherein the inhibitor is in the form of a liquid, a dust, a dry wettable powder, or a dry wettable granule.

3. The inhibitor of claim 1, wherein the inhibitor is in the form of a liquid and the Serratia marcescens biocontrol strain 3J4SM is present at a concentration of (1-9)×10⁷ CFU/mL.

4. The inhibitor of claim 3, wherein the inhibitor is a fermentation liquid of the Serratia marcescens biocontrol strain 3J4SM, and
a preparation method of the fermentation liquid includes activating the Serratia marcescens 3J4SM in an LB plate, performing culturing in an incubator at 37° C. for 24 hours, picking a single colony of Serratia marcescens with a teasing needle, transferring the single colony to a liquid medium for shaking culture for 12-24 hours, sucking 1-3% of a culture solution, and transferring the culture solution to a fresh liquid medium for shaking culture for 12-24 h, so as to obtain an antagonistic Serratia marcescens 3J4SM fermentation liquid.

5. A method for inhibiting production of aflatoxins by Aspergillus flavus, comprising:
coating surfaces of a biological sample with the inhibitor of claim 1 or mixing the inhibitor of claim 1 with a biological sample to inhibit production of aflatoxins by Aspergillus flavus.

6. A method for preparing the inhibitor of claim 1, comprising:
activating the Serratia marcescens 3J4SM in an LB plate, performing culturing in an incubator at 37° C. for 24 hours, picking a single colony of Serratia marcescens with a teasing needle, transferring the single colony to a liquid medium for shaking culture for 12-24 hours, sucking 1-3% of a culture solution, and transferring the culture solution to a fresh liquid medium for shaking culture for 12-24 h, so as to obtain an antagonistic Serratia marcescens 3J4SM fermentation liquid.
